(19) United States
(12) Patent Application Publication
(10) Pub. No.: US 2009/0128287 A1
(43) Pub. Date: May 21, 2009

(54) Terminal and Method for Determining Biometric Data of a Person, as Well as Terminal System

(76) Inventor: Dirk Dragon, Bruhl (DE)

Correspondence Address: COLLARD & ROE, P.C., 1077 NORTHERN BOULEVARD, ROSLYN, NY, 11576, US

(21) Appl. No.: 11/991,632

(22) PCT Filed: Sep. 7, 2006
(86) PCT No.: PCT/DE2006/001583

§ 371 Date: Apr. 17, 2008

Related U.S. Application Data
(60) Provisional application No. 60/715,299, filed on Sep. 8, 2005.

(30) Foreign Application Priority Data
Nov. 2, 2005 (DE) 10 2005 052 581.4

(51) Int. Cl. G06K 9/00

(52) U.S. Cl. 340/5.53

(57) ABSTRACT

The invention relates to a terminal for determining a person data, in particular for an access control or authorization comprising a housing and several devices for detecting biometric data and the person body height sensor, wherein the terminal is provided with devices for adjusting the height of the several operating detection devices.

The invention relates to a terminal for recording biometric data of a person, to a method for recording biometric data of a person, and to a terminal system having a plurality of terminals. In particular, the invention relates to such terminals, terminal systems and methods that are used for access control (physical access control) or for entry permission (logical access control).

Furthermore, the invention can also be used for border controls or for other security-relevant zones.

Terminals of this type are known from WO 2004/075097 A1, for example. The terminal therein is equipped with a camera and a fingerprint sensor. Biometric data of a person can be recorded by means of the camera and by means of the fingerprint sensor. In addition, a height sensor for the person is mounted on the housing of the terminal. The approximate height of the person is optically recognized by means of the height sensor, and the camera lens is swiveled up or down around a spindle.

WO 03/067389 A2 describes a registration operation, by means of which the passengers at an airport can be recorded. A height sensor operating by means of sound waves is provided at a recording station. A camera unit can be moved vertically by means of the height sensor mounted at the station.

WO 02/33664 A1 shows a portable apparatus having a box-like base area, in which a chip card can be inserted. By means of a knurled knob, the height of a camera on a vertically pivotal arm can be adjusted, in order to achieve the respective best angle for various users.

WO 99/06928 A1 discloses a booth in which height sensors for the person are provided at the entrance of the booth. A camera that can be displaced vertically according to the measured height is mounted on the end wall of the booth. Biometric data of the face or eyes of the person can be recorded with this camera.

EP 1280094 A2 discloses a method for recording a fingerprint, in which method the lines of the fingerprint are first oriented roughly, after which a fine adjustment is applied.

U.S. Pat. No. 5,892,838 discloses a two-stage method for biometric recognition, in which method identification of the person takes place in the first stage. The biometric data are recorded in the second stage.

WO 2004/068283 A2 discloses a biometric identification system in which a user accesses a server via a network having a local biometric recording apparatus.

WO 2004/034236 A2 also discloses a two-stage method of identification on the basis of face photographs and fingerprints.

The object of the invention is to improve the recording of biometric data with a terminal.

According to a first aspect of the invention, this object is achieved by a terminal for recording biometric data of a person, especially for physical access control or for logical access control, having a housing and a plurality of recording devices for the biometric data, and also having a height sensor for the person, whereby the terminal is equipped with means for vertically positioning a plurality of recording devices in a service condition.

For the purpose of defining terms, it must first be explained that facial proportions, a fingerprint, the iris and the retina, in particular, are considered to be data that can be recorded as biometric data. For a further definition of terms, it must be explained that the means for vertical positioning must be set up to modify the geodetic height of a plurality of recording devices. In the simplest case, this is achieved by linear vertical positioning capability. However, numerous variants are conceivable, especially a helical movement around the potential location of the person, or a linear positioning path, which is not aligned exactly vertically. The service condition is considered because the disclosed aspect of the invention is not intended to be restricted, for example, to providing a motor for vertical positioning directly at the terminal. As an example, it is conceivable that the terminal as such will be equipped only with a motor controller, while a motor is kept on hand outside the terminal, for example in a wall on which the terminal is mounted.

Among the recording devices for the biometric data, at least two should be capable of being displaced vertically by the means. Due to the fact that the recording devices can be vertically positioned in large numbers, greater ease of operation can be offered to the user. This also makes it possible to read the different biometric data in more rapidly, for example because a fingerprint sensor is moved directly to an ergonomic height for the person.

The recording operation is greatly accelerated by the disclosed aspect of the invention. As a result, a greater number of persons in a limited space can be biometrically recorded and controlled in a terminal system, by a smaller number of terminals.

According to a second aspect of the invention, the stated object is achieved by a terminal for recording biometric data of a person, especially for physical access control or for logical access control, having a housing and a recording device for biometric data, and also having a height sensor for the person, and means for vertically positioning the recording device, whereby a controller is provided that, at the beginning of a recording sequence, lowers the recording device from the top down to a service height, especially from a resting height corresponding at least substantially to a maximum height of vertical positioning.

For the purpose of defining terms, it must first be explained that the service height is that geodetic height of the recording device that is given by the controller as the ideal operating height for the person. During programming of the controller, a calculation or a table is filed in the controller, by means of which the controller allocates an ideal operating height of the recording device to each individual height of the person to be recorded. The resting height is that height at which the controller brings the recording device to rest before a recording sequence begins.

The disclosed aspect of the invention is based on the recognition that particularly good measurement results can be obtained when the recording device or the recording devices are moved downward to the service height. The reason for this is that the highest point of the person to be recorded is usually the head, which can be recognized very well by a graphical recognition program. In contrast, in a device that initiates recording at a lower height, the danger exists that other objects such as carried bags or cases as well as arms may falsify the correct alignment.

Preferably, the means for vertical positioning are set up to position the housing vertically together with the plurality of recording devices. It is particularly efficient to represent the means for vertical positioning via a drive of the housing, whereby the recording devices are mounted in or on the housing and are moved together with the housing.

In this case, it is particularly compact and efficient if the housing can be vertically positioned together with all the recording devices.

According to a third aspect of the invention, the stated object is achieved by a terminal for recording biometric data of a person, especially for physical access control or for logical access control, having a housing and a recording device for biometric data, and also having a height sensor for the person installed in or on the housing, whereby the terminal is equipped with means for vertical positioning into a service condition.

Such a terminal has a particularly compact and inexpensive construction, since both the recording device for biometric data and the height sensor are mounted in only one housing, and can be moved together to the ideal height. Furthermore, it can be constructed very easily.

If a camera is provided as a recording device for biometric data, it is proposed that it be installed at a fixed angle, or in other words that it cannot be swiveled, at least upward or downward, and preferably also rightward or leftward. Because of the existing means for vertical positioning, such movement capability of a camera would be redundant in a terminal of the type described hereinabove, and thus would make the terminal larger and more expensive than necessary.

It has already been explained that an image recording capability, a facial proportions recording capability, a fingerprint recording capability, an iris recording capability and a retina recording capability can be used as recording devices for biometric data.

If a plurality of recording devices is present and they record data about the person within a recording operation, the most reliable type of recognition can be used. For example, an analysis of the recorded facial proportions can usually be omitted if one or more fingerprints of the person, the iris of the person, or the retina of the person have been recorded, and the person can also be checked on this basis.

Alternatively, the various recorded biometric data can be analyzed concurrently. For example, it is always possible to analyze all recorded data in order to achieve the greatest possibility reliability of identification of the person.

For this purpose, a multi-stage method, in which the recognition probability is first calculated on the basis of one recorded datum, is conceivable as an alternative. If this is not sufficiently high, the other data can be used for analysis.

The means for vertical positioning are preferably provided with a motor drive mounted in stationary manner. As an example, a stationary motor drive is integrated into a vertical rail on a wall for holding the terminal housing, or is built into a permanent wall. Usually, a motor is fairly heavy, and so weight and space are saved by mounting the motor outside the vertically positionable housing. Moreover, the operating heat of the motor can be better dissipated and does not cause impairment of the electronic components in the housing of the terminal.

According to a fourth aspect of the invention, the stated object is achieved by a terminal for recording biometric data of a person, especially for physical access control or for logical access control, having a housing and a recording device for biometric data, and also having means for vertically positioning the recording device, as well as a round or tapered housing top.

It is true that a terminal of the type treated in connection with the present application preferably has image recording and may also be capable, as a height sensor, of recording and analyzing a video image, but these are all preferably integrated in the housing of the terminal. This has the consequence that space not occupied by the video equipment becomes available behind the front surface of the terminal housing, toward its rear side. In addition, the housing can preferably be moved to a very high resting height. Accordingly, it may be possible that an object placed on the terminal housing at resting height is hardly noticeable from the eye level of a person. With a round or tapered housing top, it is more difficult to deposit an object such as an explosive device on the housing top.

According to a fifth aspect of the invention, the stated object is achieved by a terminal for recording biometric data of a person, especially for physical access control or for logical access control, having a housing and a recording device for biometric data, and also having a vandalism-proof display, such as one covered with bullet-proof glass, whereby the display is configured as a touch screen.

Usually, touch screens are used only with thin protective covers. However, extensive tests have shown that a touch screen having suitable optics in the interior of the apparatus is possible even with solid, vandalism-proof or bullet-proof glass. The combination of touch screen and vandalism-proof or bullet-proof glass permits convenient control by the user and simultaneously high security against vandalism.

According to a sixth aspect of the invention, the stated object is achieved by a terminal for recording biometric data of a person, especially for physical access control or for logical access control, having a housing and a plurality of recording devices for biometric data, whereby an electronic computer unit substantially or exclusively comprises a controller, especially a microprocessor, which is set up to relay the recorded biometric data from a camera image, a fingerprint image, an iris image and/or a retina image, as graphical data, to a separately disposed control server for analysis.

This aspect of the invention contributes to data security for the recorded data of the person. In this way the terminal itself is constructed as a “dumb” terminal, which does not undertake storage or analysis of the data.

Instead, only the controller is provided as a translator, which converts the graphical data to a form suitable for transmission to the control server. In this way, preferably no datum of the user remains stored in the terminal immediately after the end of the recording operation. Even if manipulation of the apparatus takes place immediately after the end of a recording operation, or even during a recording operation, and, for example, the terminal is completely stolen, no data relevant to the person are recognizable therein. These could be obtained only from the server, but the latter is kept in an inaccessible and protected location.

The most that can be learned from the controller in the terminal is an algorithm for converting the data to formats suitable for transmission, such as an algorithm for transmitting the image data in TCP/IP data packets.

It is proposed that a terminal be equipped with an identification document reader. Such a reader can be set up, in particular, to analyze the contents of a personal ID, a passport, a driver's license, or a similar identification document. The data obtained therefrom concerning the supposed identity of the person to be checked can be used for comparison of the biometric data recorded at the terminal with identity data records stored in a database.

An advantageous method is considered to be one in which an identification entry is first made, for example via the identification document reader, and a language for voice guidance is selected on the basis of the identification entry.

Security-relevant zones are conceivable in numerous applications, especially at airports, for example. Here, passengers of the most diverse nationalities can be expected. If guidance of the person to be recorded through the respective next necessary step of recording of the biometric data is supported by a voice output, not only is this comfortable for the person to be recorded, but also it accelerates the operation as well as possible. If an official language of the issuing country is preselected on the basis of the identification document, but preferably can be changed manually, the probability that the person will understand the voice output in this language is extremely high. In most cases, manual selection of the apparatus language will not be necessary.

According to a further aspect of the invention, the stated object is achieved by a terminal system having a plurality of terminals, each terminal of which is set up for recording biometric data of a person, especially for physical access control or for logical access control, whereby each terminal is equipped with a plurality of recording devices for biometric data of the person, whereby a control server is also provided, which can communicate with the terminals, whereby the control server remotely controls the terminals, and whereby the terminals merely encrypt recorded data and relay them to the control server, without storing them and/or processing them in any other way, especially analyzing them.

In other words, this aspect of the invention also provides a “dumb” terminal, intelligent control of which resides in the control server. The control server is mounted in a separate location and therefore protected from vandalism and theft, or at least is not mounted in the same public space as the terminals. The terminals merely perform encryption, which in theory could even be omitted, except that it increases the security of the overall system, and the terminals relay the data to the control server. It has already been explained that this can be accomplished, in particular, in the form of graphic data.

The invention will be explained in greater detail hereinafter, on the basis of an exemplary embodiment, making reference to the drawing. This shows:

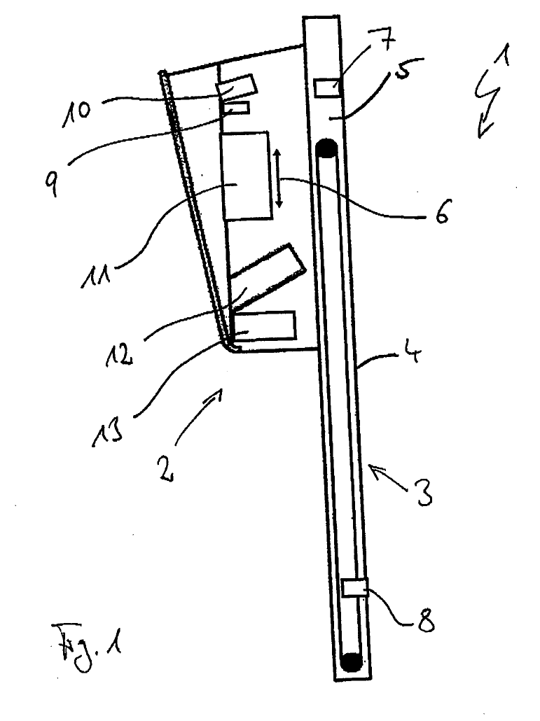

FIG. 1 a schematic side view of a recording terminal with a vertically adjustable housing on a wall mounting,

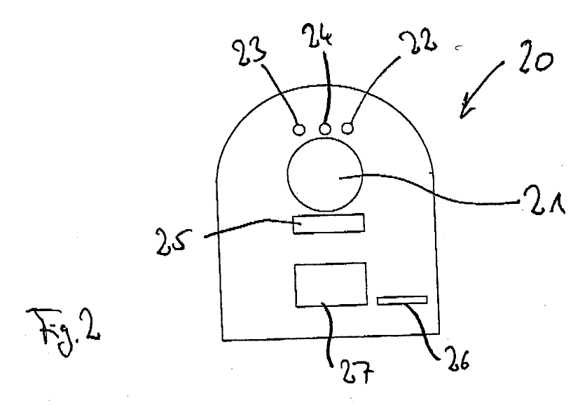

FIG. 2 a front view of an exemplary embodiment of a housing of a recording terminal,

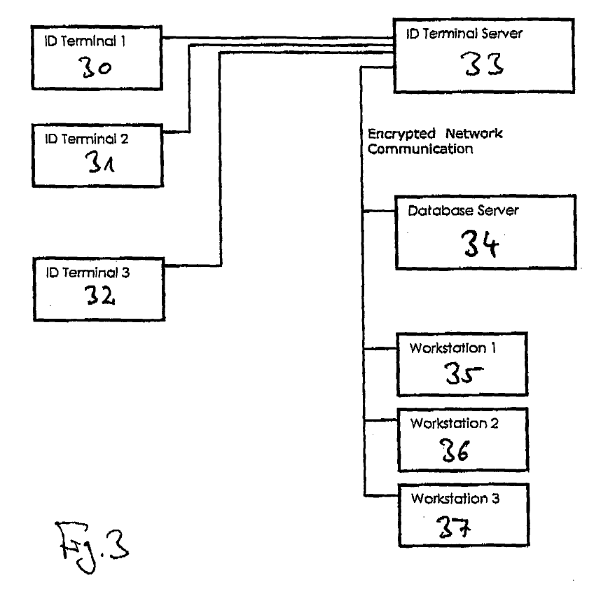

FIG. 3 schematically, the structure of a network architecture with terminals in a public space and further modules of the architecture in a closed zone, and

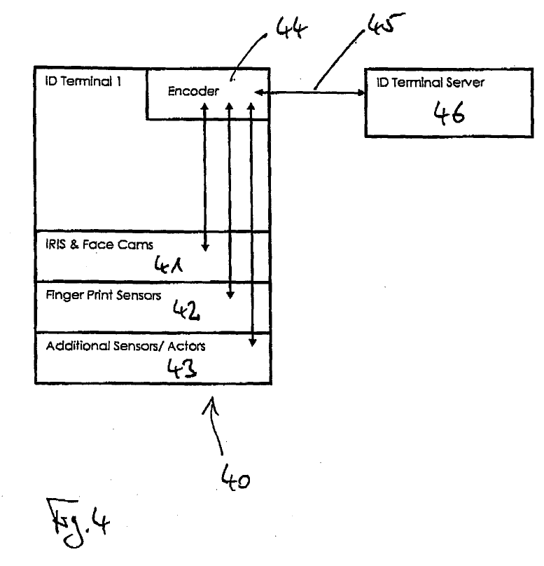

FIG. 4 schematically, the data transport within a terminal.

Terminal 1 in FIG. 1 is composed substantially of a housing 2 and an elongated wall fastening 3 having a track (not illustrated) for the housing 2.

For this purpose, the wall fastening 3 is designed to be fastened with a back side 4 to a wall, for example by way of a plurality of screw connections. In the wall fastening 3, a track guide is provided for the housing 2, which can be positioned in the track. The wall mounting 3 is a fairly flat housing made of a metal material. A motor is disposed in an open space of the wall mounting 3, for example at a position 5.

The motor is attached to the housing and, for example, to a chain drive or a similar drive, in such a way that the housing 2 can be positioned as desired along a movement direction 6, by means of the motor. In the case of the planned vertically upright installation of the wall mounting 3, the housing 2 can therefore be moved vertically upward or downward.

By means of the electronic capability of movement between an upper limit switch 7 and a lower limit switch 8 of the vertical adjustment, the housing 2 can be positioned at an ergonomically suitable operating height for the person to be recorded.

For this purpose, the body height of an approaching person is recorded by means of height sensors 9 during operation of the terminal 1. By means of this information, which can exist as graphical data, for example, or can simply be input via Yes/No recognition of whether a person is present at the level in front of the terminal, the person can very easily operate the biometric sensors after the automatic height setting of the housing 2. These sensors are, in particular, a person camera 10, with which, for example, the overall proportions of the body structure of a person can be recorded, an iris camera 11, and a fingerprint sensor 12, in a drawer resting at an angle in the housing 2.

The sequence of a recording operation for a person is as follows:

When a person approaches the terminal 1, this is recognized via the digital camera 10. On the basis of the graphically perceived data, image-recognition software decides whether a person is approaching the terminal.

If the answer is affirmative, the height of the housing 2 is automatically adapted to the person to be recorded. For this purpose, the height sensors 9 guide the housing 2 to the desired height.

The person is first asked to insert a passport or some other identification document into a drawer 13 of an identification document reader. A digital camera installed therein photocopies the identification document, and image-processing software recognizes the personal data. In an alternative embodiment, data from memory elements within the identification documents could also be read out by radio, for example by means of RFID chip technology.

The personal data are stored and checked, then a language is automatically selected on the basis of the person's nationality, which can be recognized according to the data from the identification document. By default, the software selects a national language for voice output and text output.

In the next step, the terminal prompts the person to place his/her fingers on the fingerprint sensors 12. The fingerprints are read in quickly, in succession, from a left finger and the corresponding right finger of the person. Alternatively, only one finger or more than two fingers, especially also all ten fingers, or one or both hands (palm prints) can also be read in. Depending on the specific configuration, this can be directed by guiding the user by means of outputting suitable instructions, or can be implemented by choosing suitable sensors, especially for several fingers simultaneously or for entire hands.

On the basis of the recognized data, a fingerprint encryption is generated and stored, and, if necessary, is compared with a database.

The terminal then prompts the person to look into the iris camera 11. As soon as the person moves his/her head toward the iris camera 11, a digital picture of the person's face is taken. The picture of the face is stored and, if necessary, compared with a database.

Moreover, a photograph of the eye is taken by means of the iris camera. As an example, this can be done for both eyes simultaneously or for the two eyes in succession.

The software performs a plausibility check to determine whether the two irises are different. The generated iris encryptions are stored and, if necessary, compared with a database.

On the basis of the biometrically recorded data, the software requests release of the person from decision software. The latter usually accesses a database in which persons to whom logical or physical access will not be granted or to whom logical or physical access will be granted are stored.

The terminal relays the resulting decision to the person in the national language. Logical access is then granted or refused.

Especially for the case that logical access is refused, a device can be provided for retaining the identification document in the reader drawer 13. For example, a passport can be clamped with such force that it cannot be removed from the drawer 13 without destroying it.

It must also be pointed out that the numerous recording means for the biometric data in the housing of the terminal can be provided as modules, so that the terminal can be equipped with the biometric recording devices in accordance with technical requirements. If a plurality of modules is provided, either recording with the highest identification reliability can be used, or multiple identification variants can be employed simultaneously, depending on the requirements.

If a recording action has not been successful, it will preferably be repeated. The number of repetitions for each individual step can be predetermined in the software.

Error messages and declarations during operation will be indicated by voice output as well as on the graphic display.

In the case of unsuccessful recording attempts, service personnel will be called automatically.

In the front view of an exemplary terminal housing 20 in FIG. 2, the operating and biometric recording means also known from the terminal 1 of FIG. 1 are also provided. For example, a large iris camera 21 is disposed centrally. Above this, two height sensors 22, 23 are disposed. In addition, a light source 24 for the face of the person to be recorded is seated directly above the iris camera 21.

Guidance of the person as to correct use is provided via a graphic display 25, which is preferably constructed as a touch screen.

In a lower area of the housing, at the edge, a slot 26 is provided for the passport reader, with a light source installed therein for the digital camera, and a larger drawer 27 having fingerprint sensors is provided. In the upper part of the drawer 27, illumination means (not illustrated) are also provided, in order to support the intuitive guidance of the user.

In a terminal system such as depicted in FIG. 3, a plurality of terminals 30, 31, 32 is equipped such that none of them store the recorded data of persons, but instead each merely encrypts the data and relays them to a central server 33. Only this server undertakes analysis of the data and compares them with data from a database server 34. The central terminal server 33 and the database server 34 are jointly in communication with workstations 35, 36, 37 for operation and/or analysis of the data and/or for remote control of the terminals 30, 31, 32 in an encrypted network in a security zone.

The data flow within a terminal 40, as schematically illustrated in FIG. 4, includes only the biometric data with recording devices 41, 42 of any desired type, as well as some further operating measures of operating means 43. All of these data are relayed in terminal 40 via an encryption unit 44 and a hard-wired or wireless data link 45 to the central terminal server 46. The encryption device 44 substantially or exclusively comprises a microcontroller, which cannot store any data.

In tests by the inventor, it has proved advantageous as a specific embodiment to integrate the fingerprint sensors, the passport reader, the face camera and the controller for inputs and outputs into the housing via USB ports. The iris camera can be integrated via a BNC port, and the display and any iris camera controller that may be necessary can be integrated via an RS232 interface.

All internal ports are preferably brought together via a common interface for external data transmission. This is preferably a network interface, especially an Ethernet interface, for example via a TCP/IP protocol.

The entire terminal usually has a conventional power-supply port and, in addition, a network port. The link via the network port is encrypted via the controller.

The central terminal server preferably has one network interface per connected terminal.

In a preferred embodiment, different terminal servers can even communicate with one another; for example, in an airport, a data record of the boarding passengers can already be recorded and analyzed by a first server during check-in for an international flight, then relayed to a server of an entry authority in another country. Not only is this advantageous for the security authorities, because the entry authority obtains data about the inbound passengers very early and reliably, but also it leads to faster entry processing of persons.

It is self-evident that such methods can also be accomplished with portable equipment.

1: Terminal for recording biometric data of a person, especially for physical access control or for logical access control, having a housing and a plurality of recording devices for the biometric data, and also having a height sensor for the person, wherein the terminal is equipped with means for vertically positioning a plurality of recording devices in a service condition.

2: Terminal for recording biometric data of a person, especially for physical access control or for logical access control, having a housing and a recording device for biometric data, and also having a height sensor for the person and means for vertically positioning the recording device, especially according to claim 1, comprising a controller that, at the beginning of a recording sequence, lowers the recording device from the top down to a service height, especially from a resting height corresponding at least substantially to a maximum height of vertical positioning.

3: Terminal according to claim 1, wherein the means for vertical positioning are set up to position the housing vertically together with the plurality of recording devices.

4: Terminal according to claim 3, wherein the means for vertical positioning are set up to position the housing vertically together with all the recording devices.

5: Terminal for recording biometric data of a person, especially for physical access control or for logical access control, having a housing and a recording device for biometric data, and also having a height sensor for the person installed in or on the housing, especially according to claim 1, wherein the terminal is equipped with means for vertical positioning in a service condition.

6: Terminal according to claim 1, wherein a camera is installed at a fixed angle.

7: Terminal according to claim 1, comprising an image recording capability.

8: Terminal according to claim 1, comprising a facial proportion recording capability.

9: Terminal according to claim 1, comprising a fingerprint recording capability.

10: Terminal according to claim 1, comprising an iris recording capability.

11: Terminal according to claim 1, comprising a retina recording capability.

12: Terminal according to claim 1, wherein the means for vertical positioning are provided with a motor drive mounted in stationary manner.

13: Terminal for recording biometric data of a person, especially for physical access control or for logical access control, having a housing and a recording device for biometric data, and also having means for vertically positioning the recording device, especially according to claim 1, comprising a round or tapered housing top.

14: Terminal for recording biometric data of a person, especially for physical access control or for logical access control, having a housing and a recording device for biometric data, and also having a vandalism-proof display, especially according to claim 1, wherein the display is configured as a touch screen.

15: Terminal for recording biometric data of a person, especially for physical access control or for logical access control, having a housing and a plurality of recording devices for biometric data, especially according to claim 1, wherein an electronic computer unit comprises a controller, especially a microprocessor, which is set up to relay the recorded biometric data from a camera image, a fingerprint image, an iris image and/or a retina image, as graphical data, to a separately disposed control server for analysis.

16: Terminal according to claim 1, comprising an identification document reader.

17: Terminal system having a plurality of terminals, each for recording biometric data of a person, especially for physical access control or for logical access control, having a plurality of recording devices for biometric data of the person, especially having a plurality of terminals according to claim 1, wherein a control server is provided that can communicate with the terminals, whereby the control server remotely controls the terminals, and whereby the terminals merely encrypt recorded data and relay them to the control server without storing them and/or processing them in any other way, especially analyzing them.

18: Method for recording biometric data of a person, especially for physical access control or for logical access control, having a terminal according to claim 1 wherein an identification entry is first made, and a language for voice guidance is selected on the basis of the identification entry.
